(19) United States
(12) Patent Application Publication
(10) Pub. No.: US 2008/0101357 A1
(43) Pub. Date: May 1, 2008

(54) METHOD AND APPARATUS FOR IP NETWORK INTERFACING

(76) Inventors: Paola Iovanna, Rome (IT); Umberto Properzi, Roma (IT); Claudio Porfiri, San Cesareo (RM) (IT); Laura Vellante, Roma (IT)

Correspondence Address: ERICSSON INC., 6300 LEGACY DRIVE, M/S EVR 1-C-11, PLANO, TX, 75024, US

(21) Appl. No.: 11/876,282

(22) Filed: Oct. 22, 2007

(30) Foreign Application Priority Data
Oct. 31, 2006 (EP) PCT/EP2006/067994

(51) Int. Cl. H04L 12/56

(52) U.S. Cl. 370/389

(57) ABSTRACT

A method of operating a node of a telecommunications system, the node comprising a plurality of entities each arranged to send and receive IP packets to peer entities, via a Network Address Translation function, using a layer 4 control protocol which facilitates multi-homing by allowing an entity to include more than one IP address in a layer 4 packet chunk. The method comprises maintaining at each of said plurality of entities a table mapping one or more private addresses of the entity to one or more public addresses of the Network Address Translation function, and, for each association initiation message generated by an entity, including in said layer 4 packet chunk of the message the public IP address(es) of the Network Address Translation function obtained from said table for the corresponding private IP address(es).

### CROSS-REFERENCE TO RELATED APPLICATIONS

This application claims the benefit of International Application No. PCT/EP2006/067994, filed Oct. 31, 2006, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

The present invention relates to a method and apparatus for interfacing IP networks which have different IP address spaces. The invention is applicable in particular to providing a Network Address Translation interface for nodes utilizing the Stream Control Transmission Protocol.

Operators of telecommunication networks have begun switching their networks from a traditional circuit switched functionality to an IP functionality. The later has the advantage of increased network capacity and reduced infrastructure costs, due in part to the interoperability which IP permits. In an IP signaling network (which to some extent is a virtual network sharing transport resources with the user plane network), network entities have traditionally been allocated a unique IP address within the operator domain. In order to allow these entities to communicate with entities within the domains of other operators, the Network Address Translation (NAT) protocol may be implemented at interfaces between the domains. The use of NAT allows an operator to dynamically change entities and their IP addresses within its domain without affecting the addressing processes within other domains.

Entities can be clustered together to form a single node, with each entity of the cluster being addressable using its own “private” IP address within the home domain but with all of the entities being addressable using a single “public” IP address or sharing a pool of public addresses. The NAT interface is then responsible for routing packets addressed to the common IP address or pool IP addresses onward to the correct entities.

The Transport Control Protocol (TCP) is the layer 4 protocol generally employed within IP-based telecommunication networks to both guarantee end-to-end packet delivery and to handle routing of received IP packets to higher layers (i.e. applications). TCP would therefore be implemented at each network entity within a node (comprising a cluster of entities). For a given application (identified by a port number), TCP provides for the delivery of a byte-stream, each byte of which has a sequence number. At a receiving node, the TCP layer passes the bytes, in order, to the appropriate application. TCP does not have the ability to identify individual message streams within a byte stream.

The handling of individual message streams is desirable for a number of reasons. For example, to avoid the loss of a message in one message stream relating to one matter from impacting on other message streams relating to other matters. To this end, the Internet Engineering Task Force (IETF) has specified a protocol known as the Stream Control Transmission Protocol (SCTP) which provides an alternative to TCP. SCTP provides for the establishment of SCTP “associations” between peer SCTP entities. An association is defined by the IP address/port number pairs of both ends and by a pair of Verification Tags (one allocated by each SCTP peer). An SCTP packet comprises two parts, a common header and a data chunk. The header contains the Verification Tag allocated by the sender, which provides an association identifier. The SCTP message initiating a new association contains a zero value in the Verification Tag field, whilst the data chunk is a specific chunk called an “INIT” (or initiation) chunk which contains an Initiate Tag which holds the value of the Verification Tag to be used in subsequent messages belonging to the same association. In addition, message streams within the same association are distinguished by a Stream ID which is included in the header of each DATA chunk (the first message in a given stream contains the Stream ID that will be used for the stream). The sender of an SCTP message includes a Adler-32 checksum in the message header, taken across the entire contents of the SCTP message, in order to provide additional protection against data corruption in the network.

In addition to facilitating multiple streams within the same session, SCTP provides for so-called multi-homing. Multi-homing refers to an ability to identify a single node (or node entity) by more than one IP address. An INIT chunk of an association initiating SCTP message contains the IPv4 and/or IPv6 addresses that the sending node has available to it, whilst an INIT ACK chunk of the response message contains the IPv4 and/or IPv6 addresses that the peer node has available to it.

IETF RFC 3257 □Stream Control Transmission Protocol Applicability Statement□ considers the scenario when single homed sessions are to be used, and one of the peer entities is located behind a NAT. It proposes that no transport (IP) addresses should be sent in the INIT or INIT ACK chunk. This will force the endpoint that receives this initiation message to use the source address in the IP header as the only destination address for this association. This source address will be the public IP address allocated to the initiating entity by the NAT. The IP address(es) may be omitted by the sending SCTP entity or, if the NAT is made SCTP aware, the NAT can modify the SCTP chunk appropriately. However, in this latter case, it is necessary for the NAT to compute a new 32 bit checksum. A further, significant disadvantage of both approaches is that the procedure precludes the use of multi-homing by an entity behind the NAT as by definition multi-homing requires that multiple IP addresses be included in the SCTP INIT or INIT ACK chunks.

If multi-homing is required, the NAT must have a public IP address for each represented internal IP address. A multi-entity node behind the NAT can preconfigure the NAT with IP addresses that the NAT can substitute into INIT and INIT ACK chunks. Alternatively, the NAT can have an internal Application Layer Gateway (ALG) which will intelligently translate the IP addresses in the INIT and INIT ACK chunks without the node having to first configure the NAT. In both cases, where entities behind the NAT share one or more common public IP addresses (as will typically be the case), some appropriate port number mapping must be applied by the NAT on a per association basis to ensure that an SCTP endpoint continues to receive the same port number for all messages within a given association. Again however, these approaches require the NAT to modify, in some cases, the SCTP message and thus to re-calculate the 32 bit checksum, and to manage a large number of ports.

It would be advantageous to have a system and method that overcomes the disadvantages of the prior art. The present invention provides such a system and method.

### BRIEF SUMMARY OF THE INVENTION

The present invention A private network in a telecommunications system comprises a plurality of entities each arranged to send and receive IP packets to peer entities, via a Network Address Translation function, using a layer 4 control protocol. The layer 4 protocol facilitates multi-homing by allowing an entity to include more than one IP address in a layer 4 packet chunk. Each of the entities include a table mapping one or more private addresses of the entity to one or more public addresses of the Network Address Translation function. For each association initiation message generated by an entity, included in the layer 4 packet chunk of the message are the public IP address(es) of the Network Address Translation function obtained from the table for the corresponding private IP address(es).

In a typical implementation, the plurality of entities is contained within a single physical node. The Network Address Translation function is attached to the private network and may also be within the same physical node.

In a preferred embodiment of the invention, layer 4 control protocol is the Stream Control Transmission Protocol and association initiation messages are Stream Control Transmission Protocol containing an INIT or INIT ACK chunk.

Preferably, the Network Address Translation function is implemented at a Network Address Translation entity within the node, and the Network Address Translation function does not change the layer 4 packet. A Network Address Translation bindings table is maintained at the Network Address Translation entity for each of the plurality of entities, each table mapping the private address of an entity to a public address of the Network Address Translation function and a range of association identification tags. In the case of SCTP, these association tags are Verification Tags.

Preferably, for each outgoing IP packet at the Network Address Translation entity, the private address contained in the source address field of the IP packet header is mapped to a public IP address using the corresponding bindings table, and the private IP address substituted for the public IP address. For incoming IP packets at the Network Address Translation entity, the public IP address contained in the destination field of the IP packet header and an association identification tag contained in the layer 4 header are mapped to a private IP address using the corresponding bindings table, and the public IP address substituted for the private IP address.

Each of the plurality of entities is allocated a plurality of private IP addresses that are unique within a local domain of the node, and the public IP addresses are shared between the addresses as a pool.

Other aspects of the present invention relate to a node for use in a telecommunications network, a method of configuring a node of a telecommunications system, a method of configuring a Network Address Translation entity, a method of operating a Network Address Translation entity, and a method of operating a private network within a telecommunications system, and are defined in the appended claims.

### BRIEF DESCRIPTION OF THE SEVERAL VIEWS OF THE DRAWING

In the following section, the invention will be described with reference to exemplary embodiments illustrated in the figures, in which:

FIG. 1 illustrates schematically a node within a telecommunications network which employs Network Address Translation;

FIG. 2 illustrates signaling sent from an SCTP element to a NAT device during a configuration phase:

FIG. 3 illustrates signaling sent from a NAT device to an SCTP element during a configuration phase;

FIG. 4 illustrates schematically the handling of outgoing packets at the node of FIG. 1; and

FIG. 5 illustrates schematically the handling of incoming packets at the node of FIG. 1.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

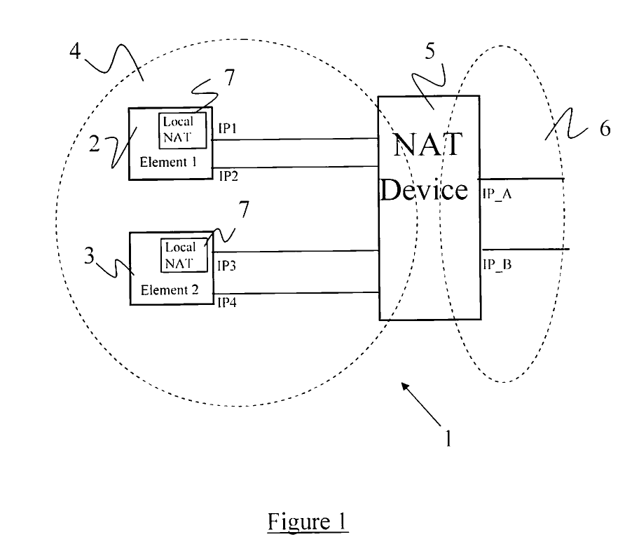

FIG. 1 depicts a high level block diagram of a node within a telecommunication network that employs Network Address Translation. Typically, all components of the node are co-located, and indeed might be provided by a number of boards within a single rack structure. The node comprises, in this example, a pair of elements, element 1 and element 2 denoted by reference numerals 2 and 3 respectively, which are located within a local or private network 4 having a first IP address space. Both elements are SCTP capable and make use of multi-homing. Each element is allocated two unique addresses within this space, namely IP1 and IP2 for element 1, and IP3 and IP4 for element 2.

The node 1 also comprises NAT device 5 which has an interface to the private network 4 identified by one or more unique IP address within the private network address space. The NAT device is coupled to public IP network 6 (public in the sense that it is accessible by other private networks, but not necessarily accessible by anyone) and has two unique IP addresses within the address space of the public network, namely IP_A and IP_B. NAT device 5 is essentially conventional, and for outgoing SCTP packets received from one of the elements it substitutes the private network IP address contained in the IP header for one of the public IP addresses. For incoming packets, the NAT device performs the reverse substitution using a mapping function as will be described below. The NAT device provides for the hiding of private network addresses in the usual way.

Each element 2, 3 is provided with a new functional entity referred to here as Local NAT 7. The role of Local NAT 7 is to perform a substitution of private IP addresses for public IP addresses at the SCTP layer, while leaving IP addresses at the IP layer unchanged. The Local NAT allows for the handling of end-to-end SCTP associations among the corresponding remote elements without impact on standard SCTP, and with only limited impact on NAT device 5.

Prior to use, it is necessary to configure both Local NATs 7 and NAT device 5 with IP address mappings. The configuration phase comprises two stages: in a first stage, a range of (Verification) Tag values is defined for and assigned to each element 2, 3, whilst in a second stage, tables storing the mapping information between private and public addresses are configured within NAT device 5 and Local NATs 7.

Considering further stage one, each element 2, 3 is assigned a range of Verification Tag values. The range is different for each element and there is no overlap between them. The assignment of the range can be performed in different ways: for example, it is possible to assign to the elements contiguous ranges of equal size, or to use an algorithm that assigns a larger range to the elements having the greatest processing capacity, and so on.

Stage two of the configuration phase consists of an exchange of messages between each element 2, 3 and NAT device 5. Only a very simple exchange of messages is required. It will be appreciated that such an exchange can be carried out using TCP and there is no need, at this stage, to establish an SCTP association between the elements and the NAT for this purpose. Element 2 or 3 initiates the exchange by communicating to the NAT device its private IP addresses and the Verification Tag range assigned to the element. NAT device 5 then maps the private IP addresses of element 2 or 3 to a public IP address or addresses and stores this mapping and the tag range in its own mapping table. The NAT device then sends the mapping information to the element. The element in its turn stores the mapping information into a mapping table of its local NAT.

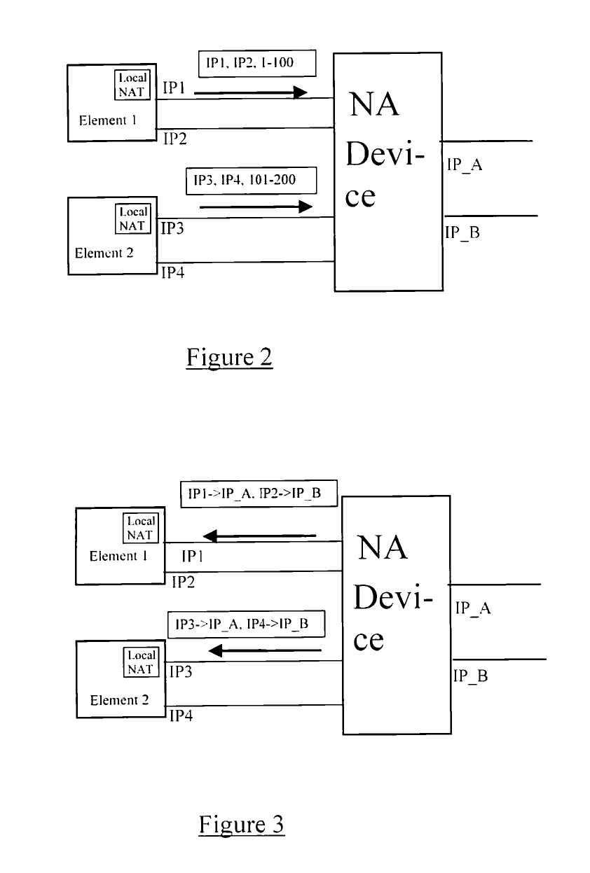

After this configuration phase has been completed for each element behind NAT device 5, all elements and the NAT device have their own mapping tables configured. FIGS. 2 and 3 illustrate the exchange of signaling between an SCTP element and the NAT device during the configuration phase, whilst Tables 1 to 3 below illustrate possible mapping tables created at the NAT device, and first and second elements respectively.

TABLE 1
Mapping Table of NAT device

| Private IP | Public IP | Range for tag |
|---|---|---|
| addresses | addresses | value |
| IP1 | IP_A | 1-100 |
| IP2 | IP_B | 1-100 |
| IP3 | IP_A | 101-200 |
| IP4 | IP_B | 101-200 |

TABLE 1
Mapping table of element 1

| Private IP | Public IP | Range for tag |
|---|---|---|
| addresses | addresses | value |
| IP1 | IP_A | 1-100 |
| IP2 | IP_B | 1-100 |

TABLE 2
Mapping table of element 2

| Private IP | Public IP | Range for tag |
|---|---|---|
| addresses | addresses | value |
| IP3 | IP_A | 101-200 |
| IP4 | IP_B | 101-200 |

When initiating an SCTP association, an element must prepare an SCTP message containing an INIT or INIT ACK chunk. Considering one of the elements 1 and 2 shown in FIGS. 2 and 3, when preparing the INIT or INIT ACK chunk the element will substitute its private network addresses for the respective public network addresses using the previously generated local mapping table. This operation is performed by the Local NAT. The element then generates a 32 bit checksum across the modified message and includes this in the SCTP message header.

Referring back to FIG. 1, NAT device 5 processes SCTP packets sent towards public network 6 differently from the SCTP packets received from the public network. However, this processing is relatively simple and consists of the translation of IP addresses at the IP level.

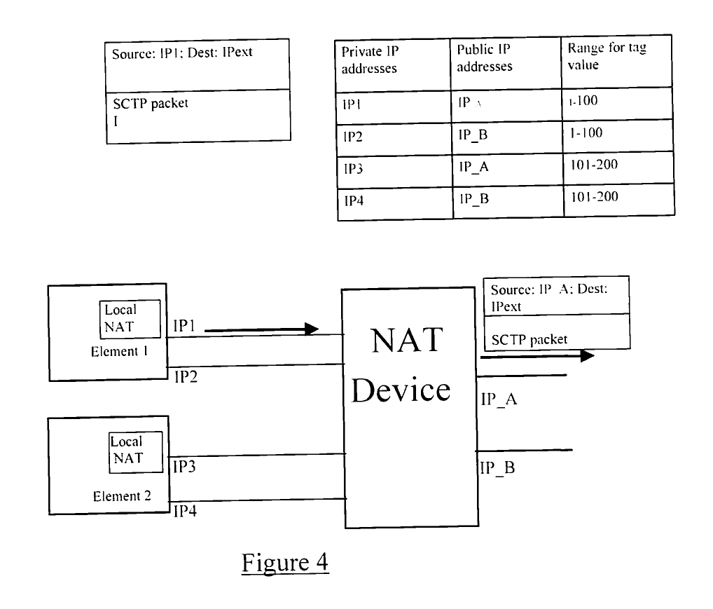

FIG. 4 depicts a high level block diagram of outgoing packets at the node depicted in FIG. 1, according to an embodiment of the present invention. When an SCTP packet sent towards the external network crosses the NAT device, the NAT device performs the following operations (for all SCTP packets)

The source private IP address is retrieved from the IP header of the packet and the NAT device executes a lookup operation in the NAT device's mapping table, using the private IP address as search key. The result of the lookup operation is the public IP address to which the private IP address has been mapped during the configuration phase. The NAT device constructs an IP header using as source IP address the public address resulting from the look-up operation and it sends the packet towards the public network, without changing any field in the SCTP packet. (NB, there is no port translation, see for example IETF RFC 3257.)

In the case of an initiation message, the peer SCTP element receiving the message will detect the presence of the two public IP addresses in the INIT or INIT ACK chunk. It will use one of these as the primary delivery address for the initiating element, whilst retaining the second public IP address in case this is required (e.g. due to a subsequent link failure).

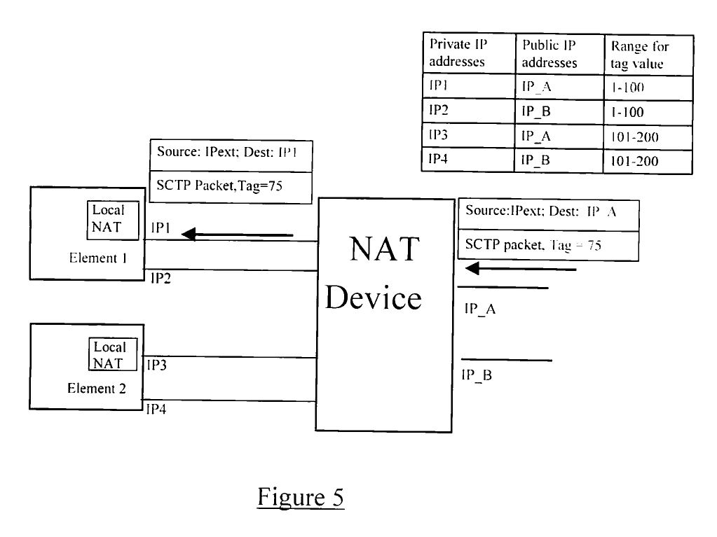

FIG. 5 is a high level block diagram depicting the handling of incoming packets at the node depicted in FIG. 1 according to an embodiment of the present invention. SCTP packets are indicated as arriving at the NAT device from the public network and which are addressed to the private network elements (and which relate to an already established SCTP association) The operation uses the destination IP address in the IP header and the Verification Tag value carried in the SCTP header. In particular, the NAT device:

obtains the destination IP address from the IP header of the arriving SCTP packet and obtains the Verification Tag value from the SCTP header;

uses this data as search keys to perform a lookup operation in its mapping table, the result being the private IP address of the element that the packet is addressed to; and

creates a new IP header containing the determined private address as destination address and sends the packet over the private network.

This operation is performed for every SCTP packet coming from the public network, with the exception of SCTP packets carrying an INIT chunk. As already described above, SCTP packets carrying an INIT chunk have the Verification Tag value in the SCTP header set to zero. The NAT is not able to perform any mapping for such a packet as there is no correspondence in the NAT table for such a Verification Tag value. Therefore, when the Verification Tag value is zero, the NAT will choose an element to which to allocate the message according to some decision algorithm. For example, the NAT decision algorithm may select an internal element based upon current loads. If two or more elements satisfy the load requirements, the element with the lower number of association in charge is chosen. If two or more elements satisfy this criterion as well, an element may be randomly selected from the candidate elements.

It will be appreciated that, as the NAT device does not need to change any data within the SCTP packet, the present invention places a minimal processing burden on the NAT device. In particular, there is no need to compute the 32-bit checksum required by SCTP, within the NAT device. This is instead calculated by the SCTP elements 2 and 3.

Within an SCTP element, the Local NAT plays a fundamental role in supporting multi-homed associations as facilitated by SCTP and in reducing the processing load placed on the NAT device. In particular, the Local NAT is responsible for including, in an INIT or INIT ACK chunk, the public IP addresses corresponding to the private, multi-homing addresses of the SCTP entity, in place of the private addresses.

A high degree of robustness with respect to link failure into the private network is introduced, in the case of both single and multi-homed associations. If a link failure happens inside the private network and an element or a NAT IP address is not reachable from the public network, the system can continue operating normally.

There are two cases to consider here. Firstly, for SCTP packets sent towards the public network, the SCTP capable element (within the private network) itself perceives a link failure and sends packets from an alternative private IP address in use for the current association. As the NAT is already configured for both (or all) private addresses, it is transparent to link failure for SCTP packets going towards the public network.

Secondly, for the case of SCTP packets coming from the public network, two scenarios can be envisaged. In the first scenario, management of link failure is the sole responsibility of the SCTP mechanism. If an SCTP packet coming from the public network is addressed to a private IP addresses which is not reachable due to a link failure, the NAT drops the packet, and the external element, via SCTP retransmission mechanisms, changes the destination IP address and resends the packet. In the second scenario, management of link failure is assigned to the NAT. If a private IP address is not reachable, the NAT forwards an incoming SCTP packet addressed to the unreachable destination towards another eligible IP address of the same destination element.

The present invention is scalable with respect to the number of SCTP capable elements within the private network as there is no limit to the number of elements that can be behind the NAT device. When a new element is added, the configuration phase is performed without impacting on the configuration of other elements or their ongoing associations.

Any NAT implementation designed to facilitate peer-to-peer SCTP exchanges should be compliant with the appropriate standards, in this case IETF RFC 2960. As far as the INIT and INIT ACK packets are concerned, compliance is the primary focus. In the case of packets containing other chunks, it is considered that the RFC requirements are also met by the mechanisms proposed here. In particular, considering an ABORT chunk that contains the Verification Tag of the sender and not the receiver, the NAT will not recognize the correct recipient and will either reject the message or forward it to the wrong recipient. In either case, the result will be an effective failure, i.e. the intended result. The proposal is also compliant with the SHUTDOWN COMPLETE, COOKIE ECHO, and SHUTDOWN ACK message requirements will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method of operating a private network within a telecommunications system, the network comprising a plurality of entities each arranged to send and receive IP packets to peer entities, via a Network Address Translation, NAT, function, using a layer 4 control protocol which facilitates multi-homing by allowing an entity to include more than one IP address in a layer 4 packet chunk, the method comprising:
maintaining at each of said plurality of entities a table for mapping one or more private addresses of the entity to one or more public addresses of the Network Address Translation function;
for each association initiation message generated by an entity, including in said layer 4 packet chunk of the message the public IP address of the Network Address Translation function obtained from said table for a corresponding private IP address.

2. The method according to claim 1, said layer 4 control protocol being the Stream Control Transmission Protocol.

3. The method according to claim 2, said association initiation messages being Stream Control Transmission Protocol containing an INIT or INIT ACK chunk.

4. The method according to claim 2, said plurality of entities being contained within the same physical node.

5. The method according to claim 4 further comprising implementing said Network Address Translation function at a Network Address Translation entity within said node.

6. The method according to claim 5, where said Network Address Translation function does not change the layer 4 packet.

7. The method according to claim 5, further comprising maintaining a Network Address Translation bindings table at the Network Address Translation entity for each of said plurality of entities, each table mapping the private address of an entity to a public address of the Network Address Translation function and a range of association identification tags.

8. The method according to claim 7, said association identification tags being Verification Tags.

9. The method according to claim 7 further comprising, for each outgoing IP packet at the Network Address Translation entity, mapping the private address contained in the source address field of the IP packet header to a public IP address using the corresponding bindings table, and substituting the private IP address for the public IP address.

10. The method according to claim 7, further comprising, for incoming IP packets at the Network Address Translation entity, mapping the public IP address contained in the destination field of the IP packet header and an association identification tag contained in the layer 4 header to a private IP address using the corresponding bindings table, and substituting the public IP address for the private IP address.

11. The method according to claim 1, wherein each of said plurality of entities is allocated a plurality of private IP addresses that are unique within a local domain of the node, and said public IP addresses are shared between the addresses as a pool.

12. A node for use in a telecommunications network, the node comprising:
a plurality of entities each of which is arranged to use a layer 4 control protocol which facilitates multi-homing by allowing an entity to include more than one IP address in a layer 4 packet chunk, each entity comprising a memory for maintaining a table mapping one or more private addresses of the entity to one or more public addresses of a Network Address Translation function, each of the plurality of entities being further adapted,
for each association initiation message generated by an entity, to include in said layer 4 packet chunk of the message the one or more public IP addresses of the Network Address Translation function obtained from said table for the corresponding private IP addresses.

13. The node according to claim 12 further comprising a further entity coupled to each of said plurality of entities via a local IP network, the further entity being arranged to implement said Network Address Translation function between the local IP network and a further IP network in which said public IP addresses are valid.

14. A method of configuring a node of a telecommunications system, the node comprising a plurality of entities each arranged to send and receive IP packets to peer entities, via a Network Address Translation function, using a layer 4 control protocol which facilitates multi-homing by allowing an entity to include more than one IP address in a layer 4 packet chunk, the method comprising:
for each entity, sending from the entity to a Network Address Translation function a mapping between the private IP addresses of the entity and ranges of layer 4 association identification tags, receiving from said Network Address Translation function in response, a mapping between said private IP addresses and public IP addresses of the Network Address Translation function, and storing the received mappings for subsequent use.

15. The method according to claim 14, said Network Address Translation function being implemented within the node, the method further comprising,
upon receipt of the mapping between the private IP addresses of an entity and ranges of layer 4 association identification tags, constructing said mapping between said private IP addresses and public IP addresses of the Network Address Translation function and sending the mapping to the corresponding entity.

16. A method of configuring a Network Address Translation entity which is responsible for implementing a Network Address Translation function on behalf of a plurality of entities each arranged to send and receive IP packets to peer entities, via the Network Address Translation function, using a layer 4 control protocol which facilitates multi-homing by allowing an entity to include more than one IP address in a layer 4 packet chunk, the method comprising:
receiving from each entity, mappings between the private IP addresses of the entity and ranges of layer 4 association identification tags, allocating to each mapping a public IP address, and storing the mappings and public address allocations.

17. A method of operating a Network Address Translation entity which is responsible for implementing a Network Address Translation function on behalf of a plurality of entities each arranged to send and receive IP packets to peer entities, via the Network Address Translation function, using a layer 4 control protocol which facilitates multi-homing by allowing an entity to include more than one IP address in a layer 4 packet chunk, the method comprising:
receiving an incoming IP packet;
identifying the destination IP address contained in the IP packet header and an association identification tag contained in the layer 4 header;
mapping the destination IP address and the association identification tag to a private IP address:
substituting the destination IP address contained in the IP packet header with said private IP address; and
forwarding the packet.
